(19) United States
(12) Patent Application Publication
(10) Pub. No.: US 2017/0019017 A1
(43) Pub. Date: Jan. 19, 2017

(54) BUCK REGULATOR WITH CURRENT CANCELLATION

(71) Applicant: QUALCOMM Incorporated, San Diego, CA (US)

(72) Inventor: Steve Hawley, Emerald Hills, CA (US)

(21) Appl. No.: 14/802,573

(22) Filed: Jul. 17, 2015

(51) Int. Cl. H02M 1/14

(52) U.S. Cl. CPC H02M 1/14

(57) ABSTRACT

A method and apparatus for cancelling ripple voltage from an output voltage. A first voltage is input to a converter, which may be a buck converter, a boost converter, or a buck/boost converter. The converter converts the first or input voltage and produces a first output voltage that containing a first ripple voltage. A second voltage is input to an inverting converter and is adjusted. This second voltage contains a second output ripple voltage that is equal and opposite to the first ripple voltage. The first and second voltages are filtered and summed The summing cancels the output ripple voltage and delivers a cleaner voltage. The apparatus includes: a converter connected to a power source, an inverting converter connected to the power source, at least one filter connected to the converter; at least one filter connected to the inverting converter; a blocking capacitor connected to a summer; and a load.

### BACKGROUND

Field

The present disclosure relates generally to wireless communication system. More specifically the present disclosure relates to methods and apparatus for a switching ripple cancellation topology for buck, boost, and buck/boost switching regulators used in power supplies for wireless communication devices.

Background

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

Wireless communication devices typically use batteries to supply power to the device. Many wireless communication devices, such as handsets, rely on switched mode power supplies. Switched mode power supplies using buck, boost, and buck/boost topologies offer the greatest efficiency, however, they generate noise. This noise poses a problem for applications requiring low noise, such as audio codecs, RF subsystems, radios, wireless local area networks (WLAN), and phase locked loop (PLL). Low input and output noise is important for power converters that may be located near sensitive RF devices, audio devices, and output amplifiers. Larger systems, such as base stations or mobile system controllers may use noise filters to handle this noise, while smaller mobile devices rely on post regulation low drop-out regulators (LDO). LDOs require voltage headroom, which increases losses. A pre-regulator provides high efficiency, but injects output noise. To minimize conducted and radiated noise there is a need for a method and apparatus for output current ripple and noise cancellation for switched mode power supply converter topologies, including buck, boost, and buck/boost topologies.

### SUMMARY

Embodiments disclosed herein provide a method for cancelling output ripple voltage from an output voltage. The method begins when a first voltage is input to a converter, which may be a buck converter, a boost converter, or a buck/boost converter. The converter converts the first or input voltage and produces a first output voltage that contains a first ripple voltage. A second voltage is input to an inverting converter and is adjusted. This second voltage contains a second output ripple voltage that is equal and opposite to the first ripple voltage. Both the first and second voltages are then filtered and summed The summing of the first and second voltages cancels the output ripple voltage and leaves a cleaner voltage to power components within an electronic device.

A further embodiment provides an apparatus for cancelling output ripple voltage from an output voltage. The apparatus includes: a converter connected to a power source, an inverting converter connected to the power source, at least one filter connected to the converter; at least one filter connected to the inverting converter; a blocking capacitor connected to a summer; and a load.

A still further embodiment provides an apparatus for cancelling a ripple voltage from an output voltage. The apparatus provides: means for inputting a first voltage to a converter; means for adjusting the first voltage in the converter; means for producing a first output voltage from the converter containing a first ripple voltage; means for inputting a second voltage to an inverting converter; means for adjusting the second voltage in the inverting converter; means for producing a second output voltage containing a second output ripple voltage; means for filtering the first and second output voltages; means for filtering the second output ripple voltage; and means for summing the first and second output voltages.

An additional embodiment provides a computer-readable non-transitory storage medium containing instructions. The instructions cause a processor to perform the steps of: inputting a first voltage to a converter; adjusting the first voltage in the converter; producing a first output voltage from the converter containing a first ripple voltage; inputting a second voltage to an inverting converter; producing a second output voltage containing a second output ripple voltage; filtering the first and second output voltages; filtering the second output ripple voltage; and summing the first and second output voltages.

### BRIEF DESCRIPTION OF THE DRAWINGS

FIG. 1 illustrates one configuration of a wireless communication system, in accordance with certain embodiments of the disclosure.

FIG. 2 illustrates a block diagram of an example of electronic components capable of transmitting in accordance with certain embodiments of the disclosure.

FIG. 3 is a circuit diagram of a noise filtering device for a switched mode power supply in accordance with certain embodiments of the disclosure.

FIG. 4 is a circuit diagram for an output ripple cancellation circuit for a buck regulator in accordance with certain embodiments of the disclosure.

FIG. 5 is a circuit diagram of the driver used for an output ripple cancellation circuit, in accordance with certain embodiments of the disclosure.

FIG. 6 illustrates ripple current and cancellation currents for continuous and discontinuous signals in accordance with certain embodiments of the disclosure.

FIG. 7 shows a comparison of pulse width modulation/pulse frequency modulation on buck regulator output ripple and noise, in accordance with certain embodiments of the disclosure.

FIG. 8 illustrates an efficiency comparison of the buck regulator output ripple cancellation apparatus with a multiple low drop-out regulator apparatus, in accordance with certain embodiments of the disclosure.

FIG. 9 is a flow diagram of a method for output ripple and noise cancellation, in accordance with certain embodiments of the disclosure.

FIG. 10 is a block diagram of a system incorporating the output ripple cancellation apparatus, in accordance with certain embodiments of the disclosure.

FIG. 11 illustrates components of a wireless device according to embodiments of the disclosure.

FIG. 12 depicts various components that may be utilized in a wireless communication device.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

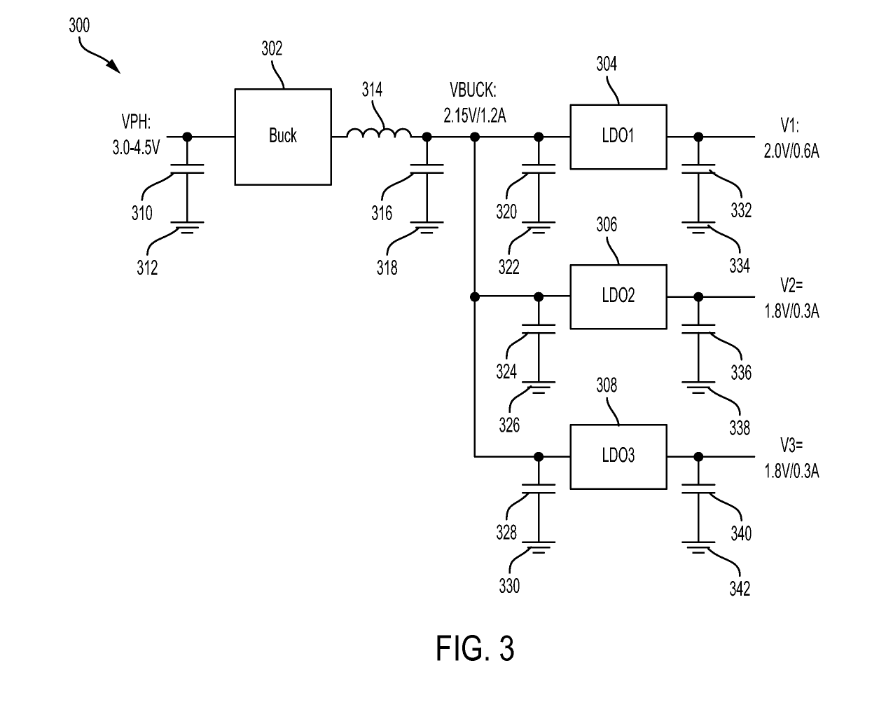

Further, it should be appreciated that modules and/or other appropriate means for performing the methods and techniques described herein, such as those illustrated by FIGS. 3-6, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

Any of the wireless communication standards described above require the wireless device have a reliable power supply. Circuits usually require direct current (DC) power supply that can maintain a fixed voltage while supplying enough current to drive a load. In many cases, the application requires a voltage lower than the output of the power supply, requiring that the power supply output voltage be stepped down to the amount needed by the specific circuit. The power supply output may also need to be regulated to ensure that no surges or other changes are transmitted to the circuit to be powered.

A voltage regulator may be placed across the output of an unregulated power supply to convert it to a regulated supply, one that eliminates any AC output voltage spikes and ripple while maintaining a constant DC output voltage with load variations. A voltage regulator automatically adjusts the amount of current flowing through a load to maintain a constant output voltage. It does so by comparing the power supply's DC output with a fixed or programmable internal reference voltage. The voltage regulator's sampling circuit monitors the output voltage by feeding a sample voltage back to an error amplifier. The reference voltage element, typically a Zener diode, acts to maintain a constant reference voltage that is used by the error amplifier. The error amplifier compares the output sample voltage with the reference voltage and then generates an error voltage if there is any difference between the two voltages. The output of the error amplifier is then fed to the current control element, often a transistor, which is used to control the load current.

The output of the power supply may contain AC output voltage spikes and ripple. The ripple factor represents the maximum variation in output voltage (in root-mean-square (RMS)) per the average DC output voltage. Noise may also be produced within the circuits of the wireless device and may become coupled to the output voltage. These factors result in a voltage that has both output noise and ripple. Output noise and ripple may adversely affect signal quality and wireless device performance

When using a power supply or battery to power sensitive circuits, it is essential to keep the variation in output voltage as small as possible. For example, when driving digital circuits from a 5 volt power supply, the variation in output voltage should be no more than five percent, or 0.25 volts, if not lower. Digital logic circuits typically have a minimum 200 mV noise margin around critical logic levels. Small analog circuits can have particular trouble with output variations and may require a variation less than one percent to operate properly. Therefore, it is highly desirable to minimize the output noise and ripple.

Many portable consumer devices, including wireless devices, use switched mode power supplies. In a switching power supply uses a high frequency inductor for filtering w. As the frequency of an alternating signal increases, the inductor size decreases, allowing the high frequency inductor to be smaller. As a result of the on/off pulsing action of the switching regulator, a switching power supply output contains a small switching ripple voltage, typically on the order of tens of millivolts resulting from the high frequency signal interacting with the output capacitor series resistance and inductance. For many wireless device applications this ripple voltage may cause problems, necessitating additional filtering.

Switched mode power supplies provide the highest efficiency however, noise is generated from the switching action. Low noise is required for operating the audio codec, RF subsystems, radios, WLAN, and PLL among other circuits in a wireless device. For larger systems resistor-capacitor (RC) or inductor-capacitor (LC) filters may be used to control this noise. For smaller systems and devices, such as wireless devices, post regulation low drop-out regulators (LDO) have been used.

In switching power supplies a switching regulator is used to provide voltage regulation. In this type of application, an inductor is used as an energy storage device. When the semiconductor is on, the current in the inductor ramps up and energy is stored. When the switch is turned off, the stored energy is released into the load. Output voltages have a ripple that must be minimized by selecting appropriate inductance and output capacitor. A buck converter provides a lower output voltage and may be used for circuits requiring less voltage than the power supply or battery output. A boost converter provides a higher output voltage. In a boost converter current does not continuously flow to the load. When the switch is “on” the inductor current flows to ground and the load current is supplied from the output capacitor. A buck/boost converter provides a voltage which is greater than, or less than, the input.

Buck converters add noise to the output signal. In a buck converter the pre-regulator provides high efficiency however, up to 30 mV peak-to-peak output noise may be injected. LDOs serve as post regulators and provide noise filtering and accurate output voltage, however, they require additional voltage headroom to maintain correct LDO operation, which increases losses. The lowest inductance yields the smallest solution size but results in high ripple current in the switching buck converter, which generates output noise. The output noise is a problem for system or device operation. Embodiments described below provide a method and apparatus to eliminate the noise source and provide output current ripple cancellation for a buck converter that may also be used with boost and buck/boost converters.

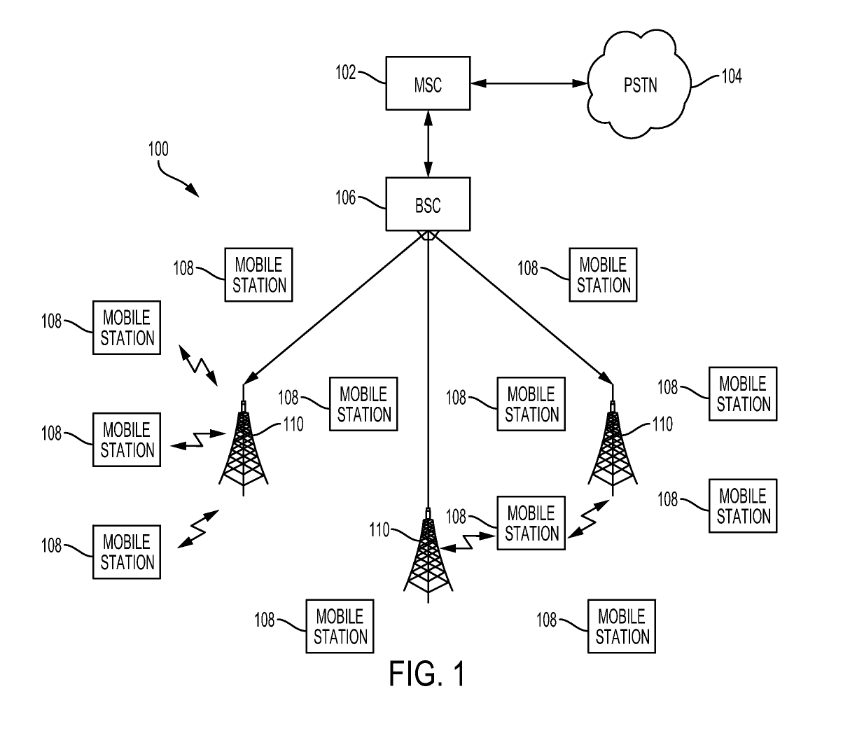

FIG. 1 illustrates a wireless system 100 that may include a plurality of mobile stations 108, a plurality of base stations 110, a base station controller (BSC) 106, and a mobile switching center (MSC) 102. The system 100 may be GSM, EDGE, WCDMA, CDMA, etc. the MSC 102 may be configured to interface wit ha public switched telephone network (PTSN) 104. The MSC may also be configured to interface with the BSC 106. There may be more than one BSC 106 in the system 100. Each base station 110 may include at least one sector (not shown), where each sector may have an omnidirectional antenna or an antenna pointed in a particular direction radially away from the base stations 110. Alternatively, each sector may include two antennas for diversity reception. Each base station 110 may be designed to support a plurality of frequency assignments. The intersection of a sector and a frequency assignment may be referred to as a channel. The mobile stations 108 may include cellular or portable communication system (PCS) telephones.

During operation of the cellular telephone system 100, the base stations 110 may receive sets of reverse link signals from sets of mobile stations 108. The mobile stations 108 may be involved in telephone calls or other communications. Each reverse link signal received by a given base station 110 may be processed within that base station 110. The resulting data may be forwarded to the BSC 106. The BSC 106 may provide call resource allocation and mobility management functionality including the orchestration of soft handoffs between base stations 110. The BSC 106 may also route the received data to the MSC 102, which provides additional routing services for interfacing with the PSTN 104. Similarly, the PTSN 104 may interface with the MSC 102, and the MSC 012 may interface with the BSC 106, which in turn may control the base stations 110 to transmit sets of forward link signals to sets of mobile stations 108.

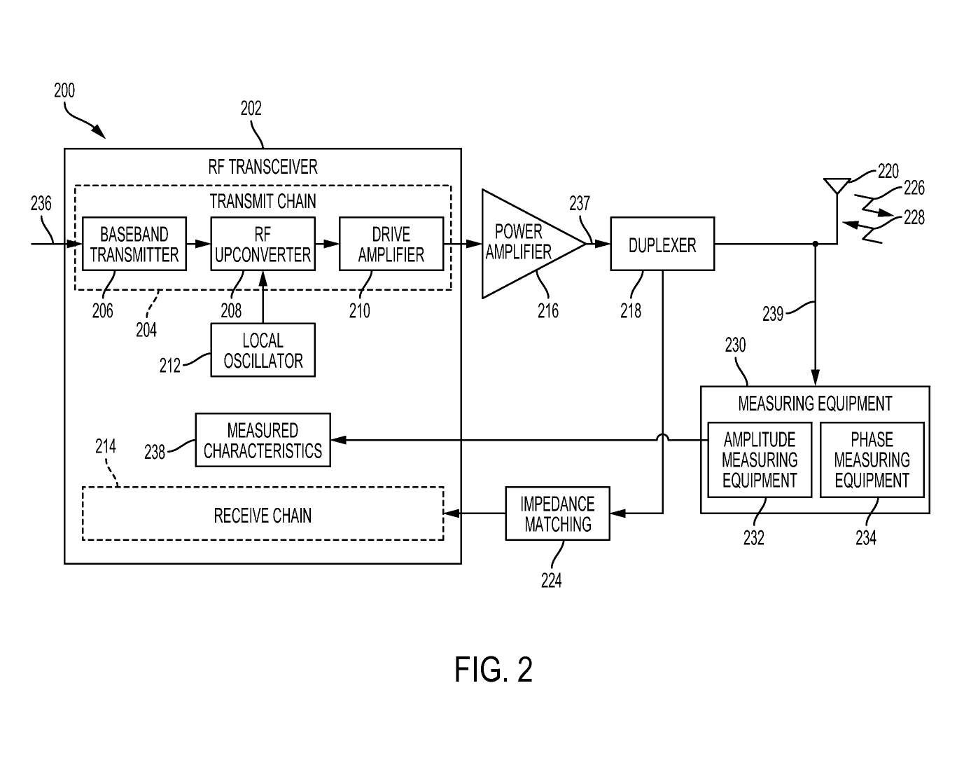

FIG. 2 is a block diagram illustrating one example of electronic components 200 capable of transmitting. The electronic components 200 may be part of a mobile station 108, a base station 110, or any other type of device that may transmit. The electronic components 200 may include a power amplifier 216. Tests may be conducted in order to optimize the performance and efficiency of the amplifier 216. In one scenario the tests may be conducted before the components 200 are marketed, that is, before an end user acquires the components 200. In one example, the configuration 200 may include a radio frequency (RF) transceiver 202. The transceiver 202 may transmit outgoing signals 226 and receive incoming signals 228 via an antenna 220. A transmit chain 204 may be used to process signals that are to be transmitted and a receive chain 214 may be implemented to process signals received by the transceiver 202. An incoming signal 228 may be processed by a duplexer 218 and impedance matching 224 of the incoming signal 228 may occur. The incoming signal 228 may then be processed by the receive chain 214.

FIG. 3 shows the use of both a buck converter and multiple LDOs on a power source, as typically found in wireless devices today. The assembly 300 provides high efficiency but injects output noise through the buck converter, and usable voltage is sacrificed to meet the needs of the multiple LDOs. A voltage is input to the buck converter 302. This voltage may range from 3.0 to 4.5V. An input ripple filter capacitor 310 and ground 312 are also connected to buck converter 302, on the input voltage. The output from buck converter 302 passes through LC buck converter output filter inductor 314. The output from LC buck converter output filter inductor 314 is also connected to LC buck output filter capacitor 316 to filter the output voltage from buck converter 302. A ground 318 is also connected to LC buck output filter capacitor 316. At this point, the voltage out of buck converter 302 is 2.15 V at 1.2 A.

Three low drop-out regulators (LDOs) are also connected to the output of buck converter 302. A first LDO 304 is connected and is also connected to input ripple filter capacitor 320, which is in turn connected to ground 322. Similarly, second LDO 306 is connected to the voltage output of buck converter 302 and is also connected to input ripple filter capacitor 324 and ground 326. A third LDO 308 is connected to the output of buck converter 302 and is also connected to input ripple filter capacitor 328 which is in turn connected to ground 330. The voltage inputs to LDOs 304, 306, and 308 are also tied together.

The output from first LDO 304 is connected to regulator output ripple filter capacitor 332 and to ground 334. In a similar fashion, the output from second LDO 306 is connected to regulator output ripple filter capacitor 336 and ground 338. Third LDO 308 also is connected to a regulator output ripple filter capacitor 340 and to a ground 342.

Noise filtering as illustrated in FIG. 3 may be used for smaller systems such as handsets, tablets, and other small electronic devices. Larger systems may use a network of RC and LC filters. Such methods have the potential to introduce noise onto a signal. For optimal performance, size and cost reduction, both conducted and radiated noise generators should to be minimized or eliminated. This noise may be produced by the interaction of the ripple current, capacitively coupled switching events interacting with the input and output capacitors shown in FIG. 3.

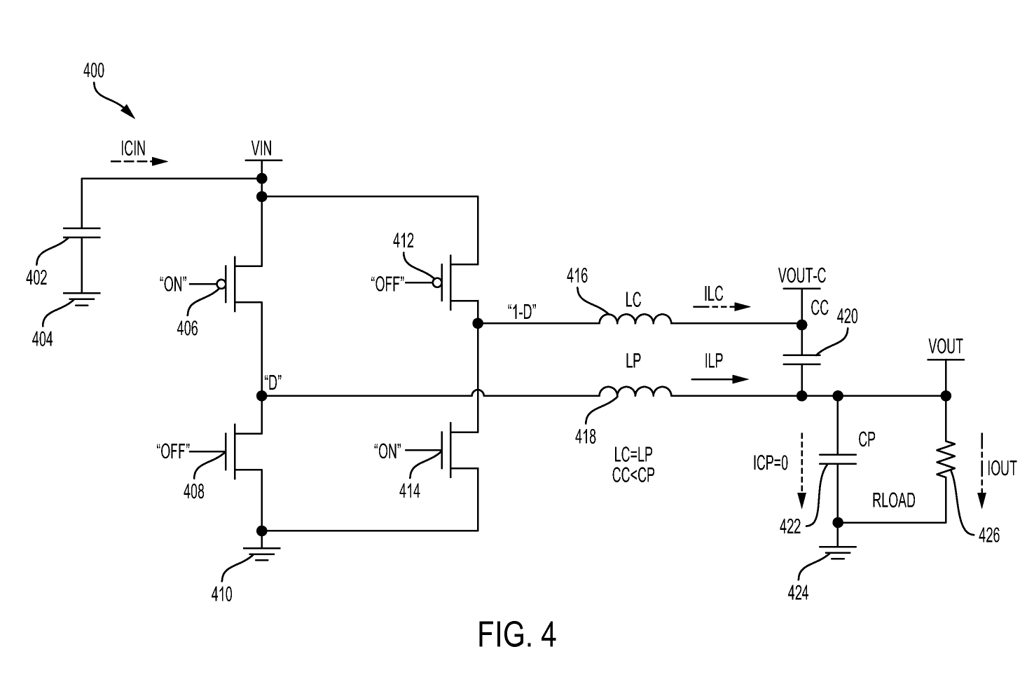

FIG. 4 illustrates an apparatus that minimizes or eliminates output or input noise caused by two phenomenons in all switching converters: inductive ripple current, and capacitive switching noise injection. This conducted noise is reduced or eliminated by eliminating the ripple current that is fed into the output capacitor. FIG. 4 shows a cancellation phase added to a switch mode buck converter. The cancellation phase shown may be added to any switched mode converter type: buck, boost, and buck/boost. The assembly 400 includes an input ripple filter capacitor 402, which serves as an input filter capacitor to a buck converter, such as buck converter 302 in FIG. 3. This input ripple filter capacitor 402 is also connected to ground 404. Input voltage is provided to a first metal oxide silicon field effect transistor (MOSFET) 406, which has an inverting input. A second MOSFET 408 is also connected to the voltage input. Both first MOSFET 406 and second MOSFET 408 are connected to ground 410.

The input voltage is also connected to a third MOSFET 412, which is also an inverting MOSFET. A fourth MOSFET 414 is connected to the input voltage and to third MOSFET 412. Third MOSFET 412 and fourth MOSFET 414 are also connected to ground 410. The output from the third MOSFET 412 is routed through LC buck output filter inductor 416, which is a part of the ripple cancellation circuit. The output from the first MOSFET 406 and the second MOSFET 408 are coupled a common node SW1 operated at a duty cycle=D and this output is routed through the LP buck output power inductor 418. The output from the third MOSFET 412 and the fourth MOSFET 414 are coupled a common node SW2 operated at a duty cycle=1-D and this output is routed through the LC buck output cancellation inductor 418. The output from LC buck output filter inductor 416 and LP buck output power inductor 418 are both coupled to cancellation capacitor 420. The output from the LP buck output power inductor 418 is also connected to power capacitor 422, which is connected to ground 424. The power from the LP buck output power inductor is also connected to an output voltage terminal and to ground through an equivalent load resistor 426.

The power phase, which is routed through the common node SW1 in FIG. 4 provides output DC load current. The much smaller cancellation phase circuit injects an equal and opposite AC ripple current. Typically the cancellation phase is one-tenth to one-fifth the size of the power phase, and may be sized based on the amount of ripple current expected. The cancellation phase operates at a duty cycle=(1-D). when the cancellation phase is active the AC ripple current through the output of power capacitor 422 is zero.

The cancellation phase circuit described in FIG. 4 eliminates the conducted noise that is generated in the series resistance and inductance. In addition the cancellation phase also cancels capacitive output coupling and radiated noise, allowing a significantly “cleaner” power to be provided. The cancellation phase may be used in pulse width modulated operation, which is continuous operation, and pulse frequency modulation, which is a discontinuous or skip mode.

In operation, the cancellation phase eliminates the switching inductor ripple current by injecting an equal and opposite AC cancellation current through the cancellation capacitor 420. A buck converter, such as buck converter 302, with cancellation eliminates the AC ripple current in the output capacitor. A boost converter with cancellation eliminates the AC ripple current from the input capacitor, when the boost converter is operated in boost mode. A buck/boost converter with cancellation eliminates the AC ripple current into the output capacitor when operated in buck mode and eliminates the AC ripple current from the input capacitor when in boost mode. Ripple cancellation for a buck/boost converter may also be provided by alternating between the buck and boost modes. The high side switch of the power phase operates at duty cycle D with on time=tON(P). The control of the power phase switches is not altered. During the off time of the power phase, the high side switch of the cancellation phase operates at a duty cycle of 1-D with on time=tON(C) and a time period equal to the off time of the high side switch of the power phase.

By maintaining an equal and opposite voltage across the cancellation inductor, which is buck output filter cancellation inductor 416, as is forced across the power inductor, which is buck output filter power inductor 418, the cancellation phase injects an AC ripple current that is equal and opposite to that generated by the power phase. This cancellation phase runs at the same clock rate as the power phase. It should be noted that the cancellation phase delivers only the AC cancellation ripple current through the cancellation capacitor 420 and does not deliver any DC output power. The power phase is responsible for delivery of the total DC output power. The switching devices, or MOSFETs 406 and 412 may be sized according to the AC current, and as a result, may be significantly smaller than the components of the power phase, MOSFETs 408 and 414.

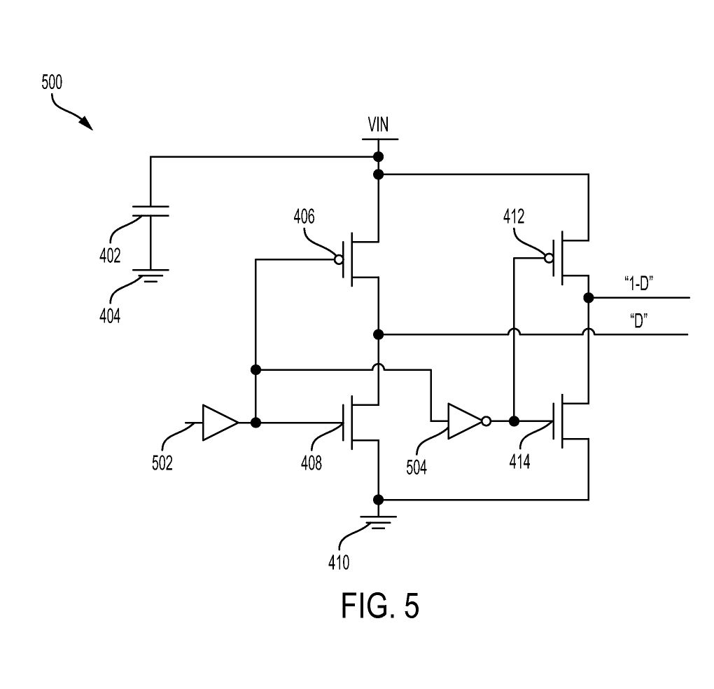

FIG. 5 is a circuit diagram of the drivers used in the output ripple cancellation circuit described above and in FIG. 4. The assembly 500 includes input ripple filter capacitor 402 which provides filtering to the buck converter. Input ripple filter capacitor 402 is also connected to ground 404. Driver 502 drives the input to inverting MOSFETs 406 and also to non-inverting MOSFET 408. Inverting MOSFET 406 and MOSFET 408 are also connected to ground 410. Inverter 504 is connected to the outputs of inverting MOSFET 406 and MOSFET 408. Inverter 504 drives the input to inverting MOSFET 412 and MOSFET 4114. A common node output of D is provided by the connection between inverting MOSFET 406 and MOSFET 408. This output is the D or power supply signal, which contains output ripple current. The output of inverter 504 is connected to inverting MOSFET 412 and MOSFET 414. Because the input to inverting MOSFET 412 and MOSFET 414 is passed through inverter 504 an equal and opposite inverted noise signal results, which is the 1-D signal. The direct current is blocked by the cancellation capacitor 420 in FIG. 4 and only the inverted ripple signal is left to be summed with the output voltage circuit containing ripple current. As a result of the summation of the two signals the output ripple is cancelled by the equal and opposite ripple that was passed through the driver circuit.

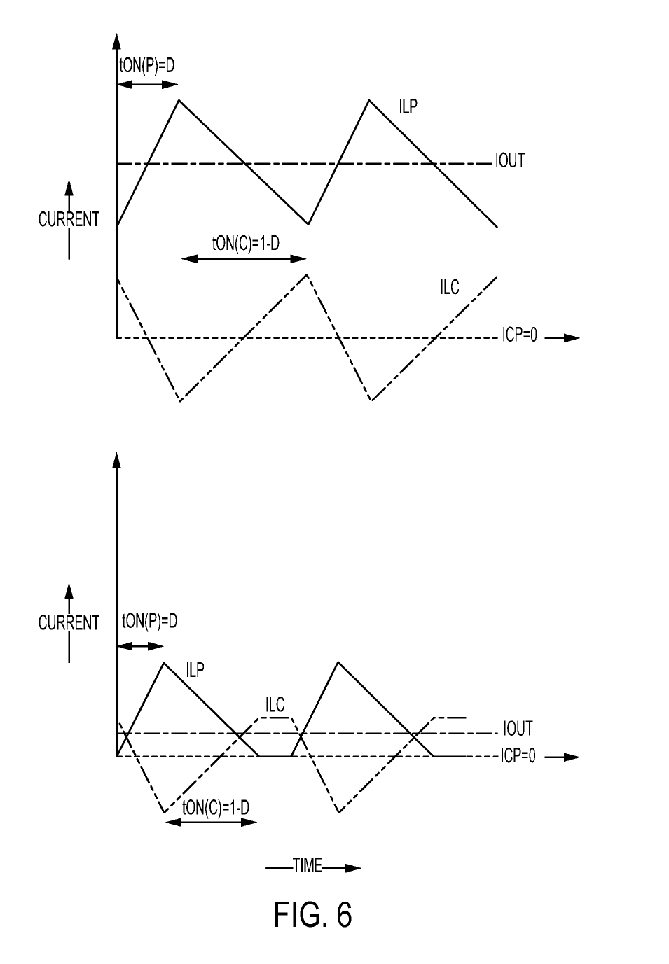

FIG. 6 in the first graph shows the ripple and cancellation currents for a buck mode converter operated in pulse width modulation mode, producing a continuous signal. The graph shows the operation of the power circuit with the ripple current operating at a duty cycle of D. The cancellation current is equal and opposite and is produced at a duty cycle of 1-D. Thus, the ripple current is cancelled by the operation of the cancellation circuit. The second graph shows the ripple and cancellation current for a buck mode converter operated in pulse frequency modulation mode, producing a discontinuous signal. The power circuit again operates at a duty cycle D and the cancellation circuit operates at a duty cycle of 1-D. The net ripple current is again zero.

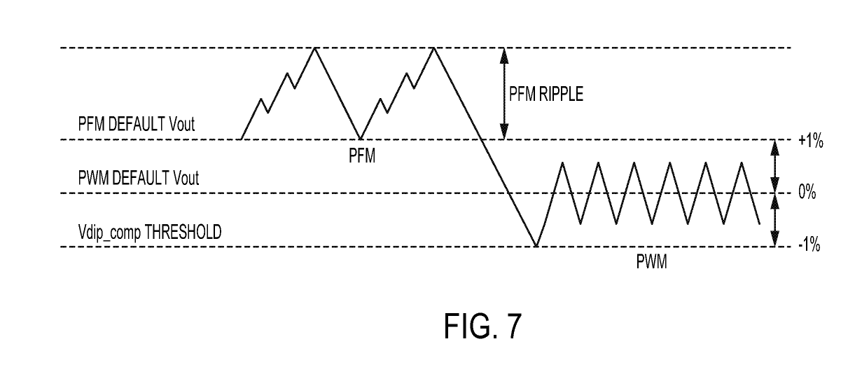

FIG. 7 shows the output ripple that would be seen when the circuit is analyzed using an oscilloscope. The output ripple is approximately 1 mV or less. Both pulse frequency modulation and pulse width modulation are shown in the simulated oscilloscope output. The negligible amount of ripple current that remains is not sufficient to cause the problems described above with respect to audio and amplifier systems typically found in small wireless devices.

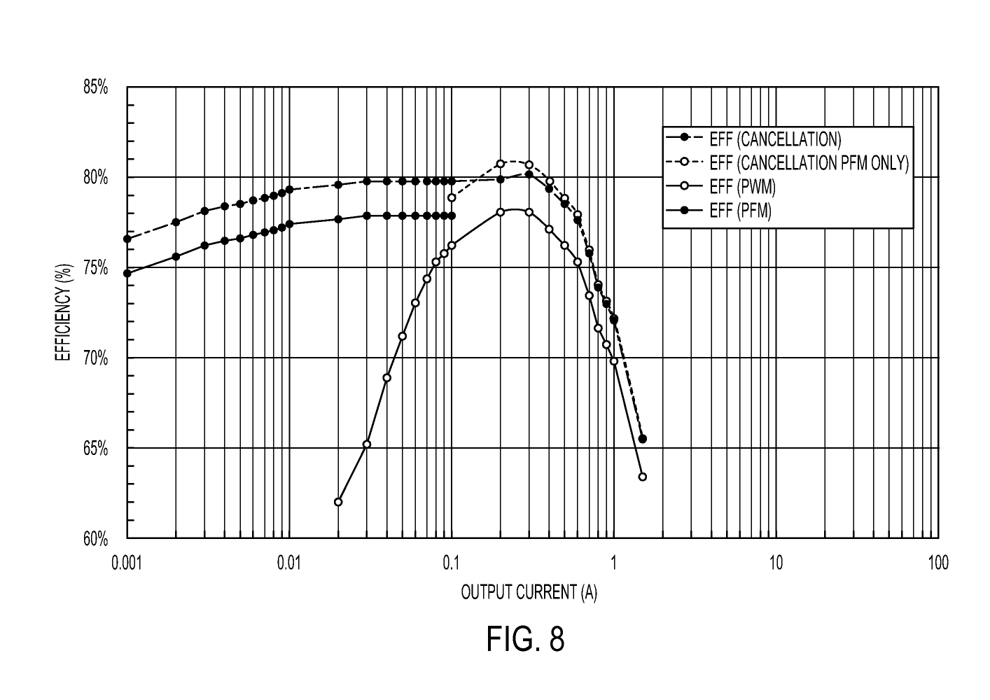

FIG. 8 provides a graph that shows the increase in efficiency through the use of the cancellation phase described above. The graph depicts both pulse width modulation and pulse frequency modulation signals with and without the cancellation phase.

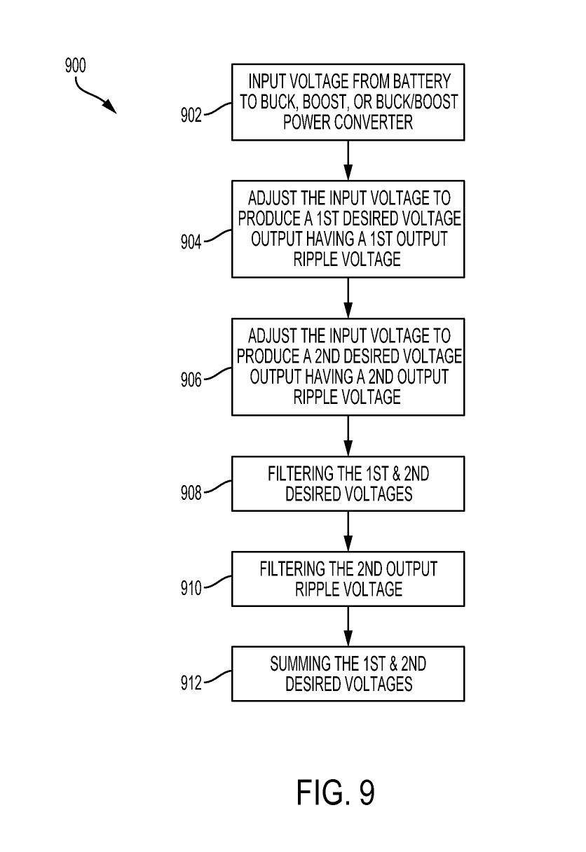

FIG. 9 is a flowchart of a method of cancelling output ripple using a noise cancellation circuit. The method 900 begins when a voltage supplied by a battery is input to a buck converter, boost converter, or buck/boost converter in step 902. The converter may increase or decrease the voltage output depending on the needs of the application. Many components require less than the typical output voltage of the battery, such as 5 volts. In such cases, the converter would typically be a buck converter. If a voltage needed is larger than that output by the battery, a boost converter is used to increase the voltage output. A buck/boost converter may be operated as either a buck or boost converter, depending on need. In step 904 the converter adjusts the first input voltage to provide a desired voltage output. This first output voltage also contains a first output ripple voltage. Concurrently, in step 906 a second adjustment is used to produce a second desired output voltage having a second ripple voltage. The first and second desired voltage outputs are then filtered in step 908. The second output ripple voltage is then filtered in step 910. This filtering may be performed by a DC blocking filter. In step 912 the first and second desired output voltages are then summed, Because the second output ripple voltage is equal and opposite to the first output ripple voltage the summing performed in step 910 cancels the ripple from the desired output voltage that will be used by the components of the wireless device.

The cancellation circuit described above produces low noise on all outputs and may reduce or eliminate low drop-out regulator power supply rejection ratio requirements and head room. In addition, using the embodiments described herein provides increased efficiency, and may reduce parts count through the elimination of LDO inductors and capacitors. This lower parts count may also result in a smaller die footprint for the device.

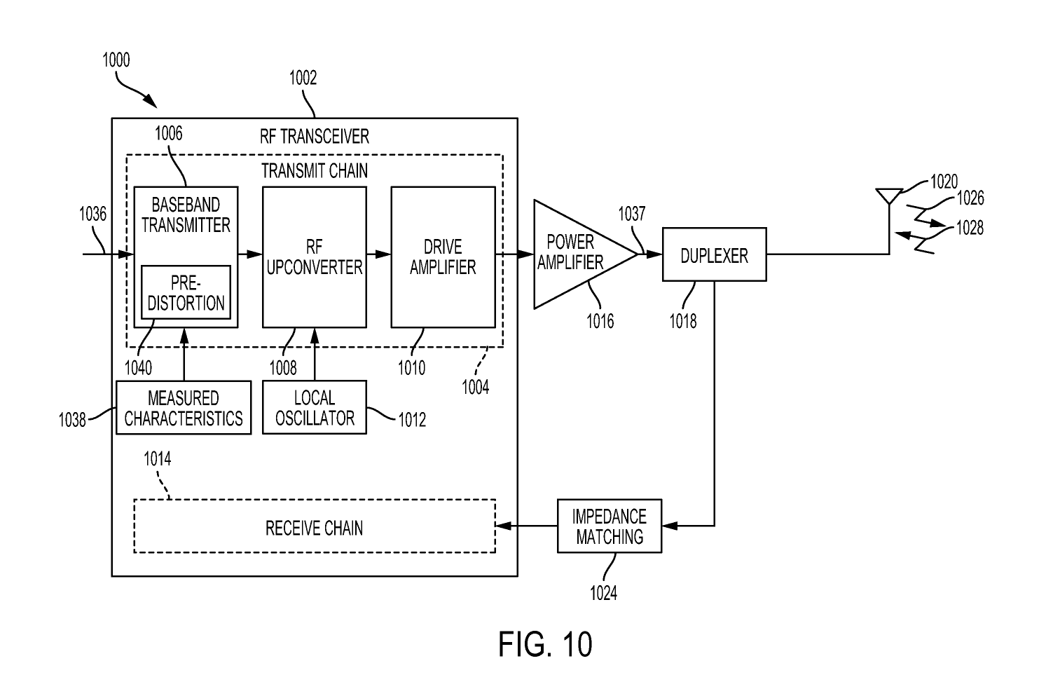

FIG. 10 is a block diagram depicting one example of a transmitting system 1000 during normal operation. The system 1000 may include an RF transceiver 1002 for transmitting outgoing signals 1026 and receiving incoming signals 1028 via an antenna 1020. The RF transceiver 1002 includes a receive chain 1014 that receives the incoming signals 1028. For example, the incoming signals 1028 may be received by the antenna 1020 and processed by duplexer 1018. An impedance matching module 1024 may match the impedance of the incoming signals 1028. The receive chain 1014 may further process the incoming signal 1028.

A transmit signal 1036 may be processed by the transmit chain 1004 before being transmitted as an outgoing signal 1026. The transmit signal may be input to a baseband transmitter 1006 which is part of the transmit chain 1004. Pre-distortion techniques may be applied to the transmit signal 1036 at the baseband transmitter 1006. The pre-distortion techniques may be applied to the transmit signal 1036. The pre-distortion may cancel or otherwise compensate for distortion that is added to the signal at a PA 1016. The pre-distortion techniques may be determined based on the measured AMAM/AMPM characteristics that were characterized as described above as part of the testing procedure of a transmitter in system 1000.

After the signal is processed by the baseband transmitter 1006, it may be upconverted to a higher frequency signal by an RF upconverter 1008. The upconverter 1008 may be controlled by a local oscillator 1012. A driver amplifier 1010 may amplify the upconverted signal. In addition, the PA 1016 may further amplify the signal. Amplification of the signal by the PA 1016 may distort the signal. the pre-distortion previously applied to the signal may cancel or otherwise compensate for the distortion added at the PA 1016. An amplified signal 1037 may be processed by the duplexer 1018 and transmitted as a transmit signal 1026 to a receiving device via antenna 1020.

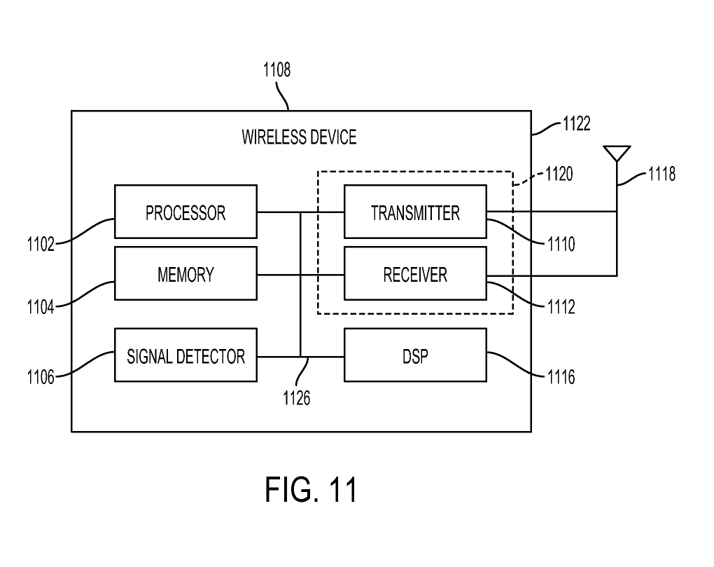

FIG. 11 illustrates various components that may be utilized in a wireless device 1108. The wireless device 1108 is an example of a device that may be used with the various systems and methods described herein. The wireless device 1108 may be a mobile station 108, a mobile telecommunications device, cellular telephone, handset, personal digital assistant (PDA), etc.

The wireless device 1108 may includes a processor 1102 which controls operation of the wireless device 1108. The processor 1102 may also be referred to as a central processing unit (CPU). Memory 1104, which may include both read-only memory (ROM) and random access memory (RAM) provides instructions and data to the processor 1102. A portion of the memory 1104 may also include non-volatile random access memory (NVRAM). The processor 1102 typically performs logical and arithmetic operations based on program instructions stored within the memory 1104. The instructions in the memory 1104 may be executable to implement the methods described herein.

The wireless device 1108 may also include a housing 1122 that may include a transmitter 1110 and a receiver 1112 to allow transmission and reception of data between the wireless device 1108 and a remote location. The transmitter 1110 and receiver 1112 may be combined into a transceiver 1120. An antenna 1118 may be attached to the housing 1122 and electrically coupled to the transceiver 1120. The wireless device 1108 may also include (not shown) multiple transmitters, multiple receivers, multiple transceivers, and/or multiple antennas.

The wireless device 1108 may also include a signal detector 1106 that may be used to detect and quantify the level of signals received by the transceiver 1120. The signal detector 1106 may detect such signals as total energy, pilot energy per pseudonoise (PN) chips, power spectral density, and other signals. The wireless device 808 may also include a digital signal processor (DSP) 1116 for use in processing signals.

The various components of the wireless device 1108 may be coupled together by a bus system 1126 which may include a power bus, a control signal bus, and a status signal bus in addition to a data bus. However, for the sake of clarity, the various buses are illustrated in FIG. 11 as the bus system 1126.

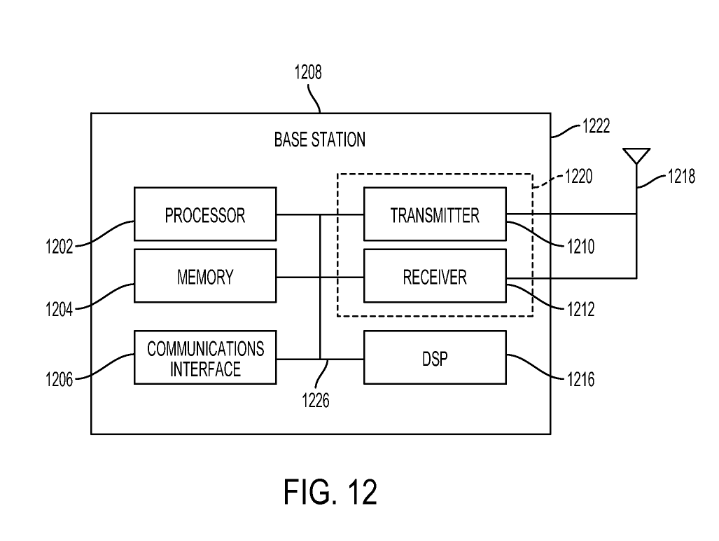

FIG. 12 is a block diagram of a base station 1208 in accordance with one example of the disclosed systems and methods. The base station 1208 is an example of a device that may be used with the various systems and methods described herein. Examples of different implementations of a base station 1208 include, but are not limited to, an evolved NodeB (eNB), a base station controller, a base station transceiver an access router, etc. The base station 1208 includes a transceiver 1220 that includes a transmitter 1210 and a receiver 1212. The transceiver 1220 may be coupled to an antenna 1218. The base station 1208 further includes a digital signal processor (DSP) 1216, a general purpose processor 1202, memory 1204, and a communication interface 1206. The various components of the base station 1208 may be included within a housing 1222.

The processor 1202 may control operation of the base station 1208. The processor 1202 may also be referred to as a CPU. The memory 1204, which may include both read-only memory (ROM) and random access memory (RAM), provides instructions and data to the processor 1202. A portion of the memory 1204 may also include non-volatile random access memory (NVRAM). The memory 1204 may include any electronic component capable of storing electronic information, and may be embodied as ROM, RAM, magnetic disk storage media, optical storage media, flash memory, on-board memory included with the processor 1202, EPROM memory, EEPROM memory, registers, a hard disk, a removable disk, a CD-ROM etc. The memory 1204 may store program instructions and other types of data. The program instructions may be executed by the processor 1202 to implement some or all of the methods disclosed herein.

In accordance with the disclosed systems and methods, the antenna 1218 may receive reverse link signals that have been transmitted from a nearby wireless device 1208. The antenna 1218 provides these received signals to the transceiver 1220 which filters and amplifies the signals. The signals are provided from the transceiver 1220 to the DSP 1216 and to the general purpose processor 1202 for demodulation, decoding, further filtering, etc.

The various components of the base station 1208 are coupled together by a bus system 1226 which may include a power bus, a control signal bus, and status signal bus in addition to a data bus. However, for the sake of clarity, the various buses are illustrated in FIG. 12 as the bus system 1226.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of cancelling ripple voltage from an output voltage, comprising:
inputting a first voltage to a converter;
adjusting the first voltage in the converter;
producing a first output voltage from the converter containing a first ripple voltage;
inputting a second voltage to an inverting converter;
adjusting the second voltage in the inverting converter;
producing a second output voltage containing a second output ripple voltage;
filtering the first and second output voltages;
filtering the second output ripple voltage; and
summing the first and second output voltages.

2. The method of claim 1, wherein the second output ripple voltage is equal and opposite of the first output ripple voltage.

3. The method of claim 1, wherein adjusting the first voltage in the converter produces a lower output voltage than the input voltage.

4. The method of claim 1, wherein adjusting the first voltage in the converter produces a higher output voltage than the input voltage.

5. The method of claim 1, wherein adjusting the first voltage in the converter produces either a higher or a lower output voltage than the input voltage.

6. The method of claim 1, wherein the second voltage signal is an inverter voltage signal from the inverting converter.

7. The method of claim 1, wherein summing the first and second output voltages sums equal and opposite output ripple voltages.

8. The method of claim 7, wherein the summation of the first and second output ripple voltages produces a zero ripple voltage.

9. An apparatus for output ripple cancellation, comprising:
a converter connected to a power source;
an inverting converter connected to the power source;
at least one filter connected to the converter;
at least one filter connected to the inverting converter;
a blocking capacitor connected to a summer; and
a load.

10. The apparatus of claim 9, wherein the converter is a buck converter.

11. The apparatus of claim 9, wherein the converter is a boost converter.

12. The apparatus of claim 9, wherein the converter is a buck/boost converter.

13. The apparatus of claim 9, wherein the blocking capacitor is a DC blocking capacitor.

14. The apparatus of claim 9, wherein the at least one filter connected to the converter and the at least one filter connected to the inverting converter are LC filters.

15. An apparatus for cancelling a ripple voltage from an output voltage, comprising:
means for inputting a first voltage to a converter;
means for adjusting the first voltage in the converter;
means for producing a first output voltage from the converter containing a first ripple voltage;
means for inputting a second voltage to an inverting converter;
means for adjusting the second voltage in the inverting converter;
means for producing a second output voltage containing a second output ripple voltage;
means for filtering the first and second output voltages;
means for filtering the second output ripple voltage; and
means for summing the first and second output voltages.

16. The apparatus of claim 15 wherein the means for adjusting the first voltage in the converter includes means for producing a lower output voltage than the input voltage.

17. The apparatus of claim 15, wherein the means for adjusting the first voltage in the converter includes means for producing a higher output voltage than the input voltage.

18. The apparatus of claim 15, wherein the means for adjusting the first voltage in the converter includes means for producing either a higher or a lower output voltage than the input voltage.

19. The apparatus of claim 15, wherein the means for summing the first and second output voltages sums equal and opposite ripple voltages.

20. The apparatus of claim 19, wherein the means for summing the first and second output ripple voltages produces a zero ripple voltage.

21. A computer-readable non-transitory storage medium containing instructions, which when executed cause a processor to perform the steps of:
inputting a first voltage to a converter;
adjusting the first voltage in the converter;
producing a first output voltage from the converter containing a first ripple voltage;
inputting a second voltage to an inverting converter;
adjusting the second voltage in the inverting converter;
producing a second output voltage containing a second output ripple voltage;
filtering the first and second output voltages;
filtering the second output ripple voltage; and
summing the first and second output voltages.

22. The computer-readable non-transitory storage medium of claim 21, further comprising instructions for adjusting the first voltage in the converter to produce a lower output voltage than the input voltage.

23. The computer-readable non-transitory storage medium of claim 21, further comprising instructions for adjusting the first voltage in the converter to produce a higher output voltage than the input voltage.

24. The computer-readable non-transitory storage medium of claim 21, further comprising instructions for adjusting the first voltage in the converter to produce either a higher or a lower output voltage than the input voltage.

25. The computer-readable non-transitory storage medium of claim 21, further comprising instructions to sum the first and second output ripple voltages.

26. The computer-readable non-transitory storage medium of claim 25, further comprising instructions that sum the first and second output ripple voltages to zero.
